(19) United States
(12) Patent Application Publication
(10) Pub. No.: US 2007/0099667 A1
(43) Pub. Date: May 3, 2007

(54) In-building wireless enhancement system for high-rise with emergency backup mode of operation

(75) Inventors: Gerald Graham, Klienburg (CA); Paul Liber, Scarborough (CA)

Correspondence Address: MCAFEE & TAFT;TENTH FLOOR, TWO LEADERSHIP SQUARE, 211 NORTH ROBINSON, OKLAHOMA CITY, OK, 73102, US

(73) Assignee: P.G. Electronics Ltd.

(21) Appl. No.: 11/261,029

(22) Filed: Oct. 28, 2005

(51) Int. Cl. H04M 1/00

(52) U.S. Cl. 455/562.1

(57) ABSTRACT

A distributed antenna system for providing distributed signal coverage within a facility of one or more wireless networks transmitting one or more RF signals. The distributed antenna system comprises a wireless base station configured to extend coverage of the one or more wireless networks; a backbone coupled to the base station; a plurality of coupler units connected to the backbone; a first plurality of antennas, each connected to one of the coupler units; a plurality of amplifiers coupled to the backbone; and a second plurality of antennas, each connected to one of the amplifiers. The plurality of amplifiers and the second plurality of antennas actively distribute the one or more RF signals during a powered condition and the first plurality of antennas passively distributes the one or more RF signals during a power failure.

### FIELD OF THE INVENTION

The present invention relates to distributed antenna systems generally and, in particular, to an in-building wireless-enhancement system for a high-rise with an emergency backup mode of operation.

### BACKGROUND OF THE INVENTION

Many facilities present problems for wireless radio frequency (RF) communication signals and require that an in-facility signal distribution system be employed to provide adequate wireless reception and coverage within the facility. These problems exist for both RF signals that originate within the facility and RF signals that originate exterior to the facility. Since RF waves in a building are attenuated not only by distance but also by losses caused by barriers such as concrete walls and floors, it is common to install enhancement systems in high-rise buildings. These enhancement systems boost the signals between portable electronic devices used in the building and external base stations responsible for sending and receiving those signals. Such systems are commonly used for both commercial cellular wireless signals and for trunked radio signals for public service responders. Facility signal distribution is often accomplished by providing an antenna distribution system that is coupled to a base station of the wireless communications system. The antenna distribution system typically includes a number of antennas distributed throughout the facility and connected to the base station with cables. The system may employ a tree-and-branch architecture, wherein uplink and downlink signals to and from the various antennas are combined using couplers.

The normal mode of operation for both types of service (e.g., cellular and trunked radio communications) is for all communication to pass through the base station, which can be located in the building or at a base site on a nearby transmission tower. Such operation depends on the use of high gain bidirectional amplifiers to boost the signals to and from the portable radios. In many systems the signals are converted to light waves and distributed over fiber optic cable, while other systems exchange the RF signals directly by using coaxial cable as the link.

These systems can provide good coverage for public service operation while the system is fully operational, but a loss of power can cause the system to cease operation and become useless.

Public service responders usually have a backup mode of operation when contact is lost with the base station during a power failure, which involves switching to simplex operation on a single frequency and talking directly between portable radios. Unfortunately, as has been shown in the past, simplex operation is only effective over short distances and only works over a few floors of a building before the signal is attenuated and contact is lost.

Accordingly, a need exists for a method and/or system for providing reliable communications in high-rise buildings during a power failure.

### SUMMARY OF THE INVENTION

The present invention provides a method and system for enhancing in-building wireless communications for a high-rise. The system and method provide an emergency backup mode of operation.

One embodiment of the present invention provides for a distributed antenna system for providing distributed signal coverage within a facility of one or more wireless networks transmitting one or more RF signals. The distributed antenna system comprises a wireless base station configured to extend coverage of the one or more wireless networks; a backbone coupled to the base station; a plurality of coupler units connected to the backbone; a first plurality of antennas, each connected to one of the coupler units; a plurality of amplifiers coupled to the backbone; and a second plurality of antennas, each connected to one of the amplifiers. The plurality of amplifiers and the second plurality of antennas actively distribute the one or more RF signals during a powered condition. The first plurality of antennas passively distributes the one or more RF signals during a power failure condition. The distributed antenna system may further comprise an emergency access port coupled to the backbone. Additionally, one or more portable radios may be in use within the facility and the distributed antenna system may further comprise a command post portable radio connected to the emergency access port for communicating passively through the first plurality of antennas with the one or more portable radios. The distributed antenna system may further comprise a repeater having a normally closed relay and being coupled to the backbone and a directional antenna coupled to the repeater. The directional antenna may send and receive public service signals from a public service base station and distribute the public service signals to the one or more portable radios over the backbone during a power failure. The distributed antenna system may further comprise a central monitoring unit coupled to the backbone for monitoring the status of the distributed antenna system. In one example, the one or more wireless networks may be a PCS cellular network and a specialized mobile radio network. The backbone may be a coaxial cable distribution backbone. The plurality of amplifiers may be bi-directional amplifiers and the facility may be a high-rise building having a plurality of floors. Each floor may have at least one of the first plurality of antennas and at least some of the plurality of floors may have at least one of the plurality of amplifiers and at least one of the second plurality of antennas. The high-rise building may have a stairwell and a plurality of floors. The first plurality of antennas may be located in the stairwell and the coupler units may be low-loss coupler units.

Another embodiment of the present invention provides for a distributed antenna system for providing distributed signal coverage within a high-rise having a plurality of floors. The distributed antenna system comprises a network backbone running substantially the height of the high-rise; one or more wireless base stations for receiving wireless signals, each of the wireless base stations being coupled to the network backbone; at least one passive antenna located on each of the plurality of floors, each of the passive antennas being connected to the network backbone; one or more amplifiers located on at least one of the plurality of floors, each amplifier being coupled to the network backbone; and at least one further antennas, each of the amplifiers being coupled to at least one of the further antennas. The amplifiers and coupled further antennas distribute the wireless signals during a powered condition and the passive antennas distribute a second set of signals among the floors during a power failure. The second set of signals may include public service wireless signals. The distributed antenna system may further comprise an emergency access port coupled to the network backbone. A command post portable radio may be coupled to the emergency access port to communicate passively with one or more portable radios for use within the high-rise through the passive antennas via the network backbone. The distributed antenna system may further comprise a repeater having a normally closed relay coupled to the backbone and a directional antenna located exterior to the high-rise and coupled to the repeater for sending and receiving public service signals from a public service base station. The public service signals may be either actively distributed to the one or more portable radios over the further antennas during normal powered conditions or passively distributed to the one or more portable radios over the passive antennas during a power failure.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present invention, and in which:

FIG. 1 shows a block diagram of a system for providing communications to a high-rise building according to one example embodiment of the present invention; and

FIG. 2 shows a block diagram of a system for providing communications to a high-rise building according to another example embodiment of the present invention.

Similar reference numerals are used in different figures to denote similar components.

### Description of Specific Embodiments

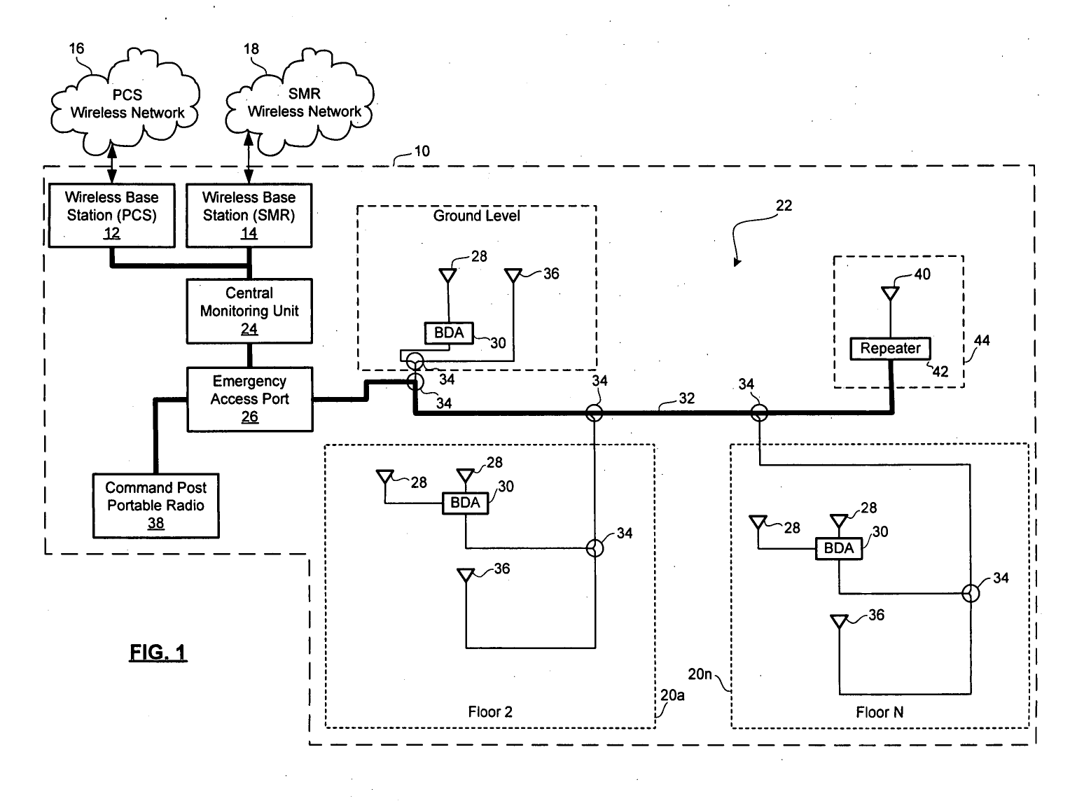

Referring to FIG. 1, a block diagram is shown of a system for providing communications to a facility 10 in accordance with one example of the present invention. The facility 10 has one or more wireless base stations, indicated by numerals 12 and 14, which are respectively coupled to wireless networks 16 and 18. The wireless networks 16 and 18 may be cellular networks, PCS networks, SMR band networks, paging networks, or other wireless communication networks for interfacing with mobile devices. The wireless networks 16 and 18 may operate using AMPS, DAMPS, NADC, CDMA, TDMA, GSM, iDEN or other modulation protocols. In one example, the wireless network 16 is a PCS network and the wireless base station 12 handles PCS signals while the wireless network 18 is a specialized mobile radio (SMR) network and the base station 14 handles SMR signals. Alternatively, in small facilities, the connection to the external networks 16 and 18 may be via repeaters to external base stations rather than placing microcells in the facility, as shown in FIG. 1.

The facility 10 may be an indoor facility, an outdoor facility or a mixture of enclosed and open-air spaces. Without limiting the generality of the foregoing, the facility 10 may be a shopping centre, an underground concourse, a subway system, a stadium, a hotel, an office tower, an entertainment center, or a business or industrial complex. In the embodiment shown in FIG. 1, the facility 10 includes a high-rise building having a plurality of floors 20a-n, indicated individually as 20a, . . . , 20n.

A distributed antenna system, generally denoted by the reference numeral 22, is provided within the facility 10. The distributed antenna system 22 is coupled to the wireless base stations 12 and 14 to provide adequate wireless coverage for the wireless networks 16 and 18 throughout the facility 10. The wireless base stations 12 and 14 may be further coupled to a central monitoring unit 24 and an emergency access port 26. The distributed antenna system 22 further includes a plurality of active antennas 28 positioned in a variety of locations throughout the facility 10, including on at least some of the floors 20a-n. The distributed antenna system 22 further includes a number of bidirectional amplifiers (BDAs) 30 to compensate for cable losses at various points in the distributed antenna system 22. The active antennas 28 are coupled to the BDAs 30 for active transmission/reception of the RF signals. The BDAs 30 are each coupled to the wireless base stations 12 and 14 by coaxial cable, fibre optic cable, twisted pair wiring, or any other signal medium, whether wired or wireless. In the present example, a co-axial cable distribution system is employed having a vertical backbone or riser 32, as indicated by the thick line in FIG. 1. The distributed antenna system 22 may be deployed in a tree-and-branch architecture using coupler units 34 to split signals between branches. It will be understood that the distributed antenna system 22 may be deployed using other architectures.

The distributed antenna system further includes a number of passive antennas 36 that are each coupled directly to the coupler units 34 without the use of a bidirectional amplifier. The passive antennas 36 are coupled directly to the backbone 32 for passive transmission/reception of the RF signals in the event of a power failure. Without power, the BDAs 30 cease to function and the active antennas 28 no longer function, as the BDAs 30 become an open circuit between the active antennas 28 and the coupler units 34. The passive antennas 36 are ideally located in a stairway on each of the floors 20a-n to provide emergency RF coverage within the stairway of the high-rise. The passive antennas 36 function to provide some level of connectivity for the distributed antenna system 22 during a power failure, described in greater detail below.

The central monitoring unit 24 detects faults and receives information signals on the distributed antenna system 22 and generates alarms, reports or other outputs. The central monitoring unit 24 may generate alarm signals for display on an in-building monitoring station or computer. The alarm signals may also be transmitted through modem connection, Ethernet connection, or other network connection to an external system. The central monitoring unit 24 is an optional feature of the distributed antenna system 22.

In one example, the distributed antenna system 22 provides a building enhancement system that provides RF signal coverage in the absence of a power failure. Additionally, the distributed antenna system 22 provides a method for public service responders (e.g., SMRs) to communicate to each other within a high-rise building even if all power in the building is lost.

A high-rise building typically has at least two vertical cores, which contain stacked equipment rooms and one or more stairways. The distributed antenna system 22 routes signals up and down over the backbone 32 located in the vertical column of the equipment rooms and uses the BDAs 30 located in the floor 20a-n equipment rooms to boost the signals for distribution to and from the active indoor antennas 28 on the floors 20a-n.

In the current example, the distributed antenna system 22 implements the backbone 32 using a low loss coaxial cable that joins the coupler units 34 on each of the floors 20a-n. The coupler units 34 may each be low loss taps or low loss splitters, depending on the particular application of each of the coupler units 34. A coupler tap port connects via the coupler units 34 (e.g. a 2-way power divider) to both the passive antenna 36 in the stairway and to the BDA 30 in the equipment rooms. The low loss taps and the 2-way power dividers are shown generally as the coupler units 34 in FIG. 1. Wireless signals from the wireless base stations 12 and 14, typically placed in the basement or on the top floor of the facility 10, are connected to the backbone 32. During normal operation, all wireless signals are tapped from the BDAs 30 on the floors 20a-n that employ the BDAs 30 and then distributed to the active antennas 28 on the same floor. However, the passive connection provided via the passive antennas 36 to the backbone 32 allows signal connectivity between portable radios in the stairways and on the floors 20a-n even if the BDAs 30 are disabled due to a power failure or for other reasons. Additionally, floors that are closest to the wireless base stations 12 and 14 may only need the passive antennas 36 to effectively transmit and receive the RF signals.

If, in the absence of building power, a portable radio transmits in the stairway, passive connectivity with other floors through the passive antennas 36 and the backbone 32 allows portable radios on other floors to receive the signal. This passive connectivity may be limited to a range of a certain number of floors, depending on the cable loss. Regardless, this enables responders in the stairway to communicate with each other over more floors than would normally be possible without the passive connectivity provided by the passive antennas 36 and the backbone 32.

The optional emergency access port 26 provides an additional element. The emergency access port 26 is typically placed at a command post tap in the vertical riser at the ground floor level of the facility 10. By using a jumper cable in place of a normal antenna, a command post portable radio 38 may be connected directly to the backbone 32 without using the portable radio's antenna. The normal antenna to antenna propagation loss between the command post portable radio 38 and the distributed antenna system 22 is reduced as the cable backbone 32 becomes the broadcasting and receiving antenna for the command post portable radio 38. The command post portable radio 38 is then able to communicate with other portables at any location, across all of the floors 20a-n.

One possible additional arrangement for enhancing signals to and from an additional public service base station (not shown) is to use a directional roof antenna 40 and a repeater 42 located on a roof 44 of the facility 10 to boost public service signals into the distribution system 22. In the event of a loss of power to the repeater 42, contact would normally be lost with the public service base station. The present invention provides for a portable radio that has been directly connected to the backbone 32 through the emergency access port 26 to talk to the public service base station through the backbone 32 if the repeater 42 is equipped with a normally closed relay, thus bypassing the repeater 42 in the event of a power failure. Additionally, the portable radios may be able to communicate with the public service base station using the passive antennas 36.

The central monitoring unit 24 may further function as a status monitor that may verify the presence of all the interior and exterior antennas 28, 36, and 40 in the system 22 and the health of the BDAs 30 and may report any faults to a remote site or trip local alarm circuits to alert the appropriate people. The presence of the active antennas 28 and the passive antennas 36 is monitored using both sensing capabilities incorporated in each RF output of the BDAs 30, and where required, a separate antenna monitor device (not shown) that may be coupled to the passive antennas 36. The disconnection of any antenna from its BDA 30 or antenna monitor triggers a fault alarm within a predetermined time.

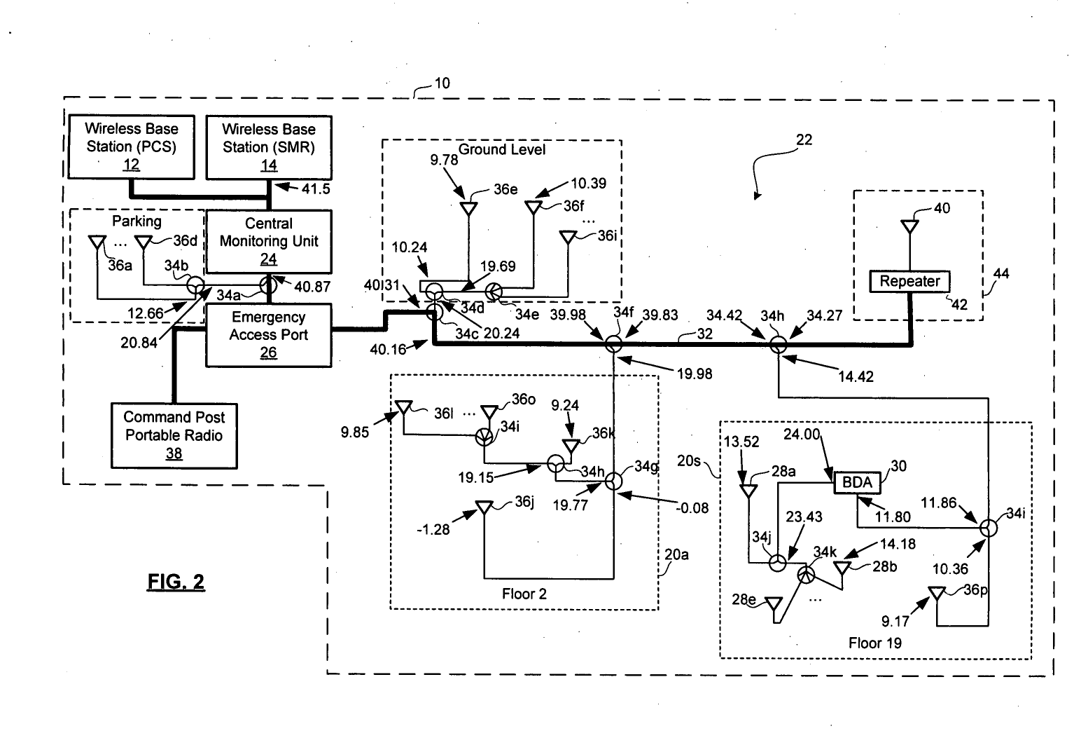

Referring to FIG. 2, a block diagram is shown of a system for providing communications to a facility in accordance with another example of the present invention. The facility 10 and distributed antenna system 22, shown in FIG. 2, are similar to those shown in FIG. 1. FIG. 2 illustrates a parking concourse level passive antenna network coupled to the backbone 32 in between the central monitoring unit 24 and the emergency access port 26. Additionally, the BDAs 30 have been removed from the antenna networks shown at ground level and the floor 2 (indicated as 20a). Additionally, the highest floor generally shown as 20n in FIG. 1 has been replaced by a specific example of a floor 19 shown as 20s. In the example shown in FIG. 2, the signal level reaching the passive antennas 36 for the first several floors may be high enough such that the BDAs 30 are not needed, leaving only passive antennas 36 on the lower floors in the facility 10. The coupler units 34 shown in FIG. 1 are shown in FIG. 2 as coupler 34a-k, individually represented as 34a, . . . , 34k. Likewise, the passive antennas 36 are shown in FIG. 2 as passive antennas 36a-p, individually represented as 36a, . . . , 36p. The active antennas 28 are shown in FIG. 2 as active antennas 28a-e, individually represented as 28a, . . . , 28e. Numbers and arrows are shown in FIG. 2, representing the power levels in dBm achieved at various points in the distributed antenna system 22 according to a simulation performed in accordance with one example embodiment of the present invention.

In the present example, the wireless base station 14 provides an SMR signal to the backbone 32 having a signal power of 41.5 dBm. The signal power at the output of the central monitoring unit 24 is 40.87 dBm, where the signal is provided to the coupler unit 34a (e.g., a 20 dB low loss tap), feeding an antenna network located in the parking concourse of the facility 10. The output of the coupler unit 34a provides a signal power of 20.84 dBm to another coupler unit 34b (e.g., a four way splitter), which feeds cables to four passive antennas 36a-d (only two of the passive antennas 36a-d are shown at the parking concourse level), individually indicated as 36a, . . . 36d, at a signal power of 12.66 dBm.

The backbone 32 further provides a signal power of 40.31 dBm to the coupler unit 34c (e.g., a 20 dB low loss tap) located at the ground level. The coupler unit 34c provides a signal power of 20.24 dBm to the coupler unit 34d (e.g., a 10 dB low loss tap), which provides a signal power of 10.24 dBm to a cable that connects to the passive antenna 36e, which broadcasts the signal at 9.78 dBm. The coupler unit 34d further feeds a cable to the coupler unit 34e (e.g., a four way splitter) with a signal power of 19.69 dBm, which feeds four further passive antennas 36f-i, individually indicated as 36f, . . . , 36i, with a broadcast signal power of 10.39 dBm.

The backbone 32 further provides a signal power of 40.16 dBm leaving the coupler unit 34c at the ground level. The signal power arriving at the coupler unit 34f (e.g., a 20 dB low loss tap) located on the backbone 32 at the second floor 20a level is 39.98 dBm. The coupler unit 34f provides a signal power of 39.83 dBm to the backbone 32 above the second floor 20a level and a signal power level of 19.98 dBm to the passive antenna network on the second floor 20a. The second floor 20a has a first passive antenna 36j having a broadcast power level of −1.28 dBm. The first passive antenna 36j is coupled to the coupler unit 34g (e.g., a 20 dB low loss tap), which provides a signal power of 19.77 dBm to the coupler unit 34h (e.g., a 10 dB low loss tap) that powers a second passive antenna 36k with a broadcast power of 9.24 dBm. The coupler unit 34h further provides a signal power of 19.15 dBm to the coupler unit 34i (e.g., a four way splitter), which feeds four further passive antennas 36l-o, individually indicated as 36l, . . . 36o, with a broadcast power of 9.85 dBm.

The backbone 32 further feeds a number of floors 20b-r (not shown), until the backbone 32 arrives at the floor 20s (e.g., the 19^{th} floor). The backbone 32 has a signal power of 34.42 dBm arriving at the coupler unit 34h (e.g., a 20 dB low loss tap). The coupler unit 34h supplies a signal power level of 14.42 dBm to a cable connecting to a further coupler unit 34i (e.g., a splitter). The coupler unit 34i supplies a signal power of 10.36 dBm to a cable connecting to the passive antenna 36p, broadcasting at a signal power of 9.17 dBm, and a signal power of 11.86 dBm to a cable connecting to the BDA 30. The BDA 30 receives 11.8 dBm and amplifies the signal power to 24.00 dBm and supplies the signal to the coupler unit 34j (e.g., a 10 dB low loss tap). The coupler unit 34j is coupled to the active antenna 28a, broadcasting with a signal power of 13.52 dBm, and a further coupler unit 34k (e.g., a four way splitter). The coupler unit 34k is connected to the 4 active antennas 28b-e, individually indicated as 28b, . . . , 28e. The four active antennas 28b-e broadcast with a signal power of 14.18 dBm. While the distributed antenna system 22 is shown in FIG. 2 with exemplary 20 dB and 10 dB low loss taps and splitters in specific locations and an exemplary number of BDAs 30, passive antennas 36, and active antennas 28, any number and configuration of taps, splitters, amplifiers, and antennas may be used to meet the design criteria of a particular application.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A distributed antenna system for providing distributed signal coverage within a facility of one or more wireless networks transmitting one or more RF signals, the distributed antenna system comprising:
a wireless base station configured to extend coverage of the one or more wireless networks;
a backbone coupled to the base station;
a plurality of coupler units connected to the backbone;
a first plurality of antennas, each connected to one of the coupler units;
a plurality of amplifiers coupled to the backbone; and
a second plurality of antennas, each connected to one of the amplifiers,
wherein the plurality of amplifiers and the second plurality of antennas actively distribute the one or more RF signals during a powered condition and the first plurality of antennas passively distributes the one or more RF signals during a power failure.

2. The distributed antenna system according to claim 1, further comprising:
an emergency access port coupled to the backbone.

3. The distributed antenna system according to claim 2 where one or more portable radios are in use within the facility, the distributed antenna system further comprising:
a command post portable radio connected to the emergency access port for communicating passively through the first plurality of antennas with the one or more portable radios.

4. The distributed antenna system according to claim 1 where one or more portable radios are in use within the facility, the distributed antenna system further comprising:
a repeater having a normally closed relay and being coupled to the backbone; and
a directional antenna coupled to the repeater for sending and receiving public service signals from a public service base station and distributing the public service signals to the one or more portable radios over the backbone during a power failure.

5. The distributed antenna system according to claim 1, further comprising:
a central monitoring unit coupled to the backbone for monitoring the status of the distributed antenna system.

6. The distributed antenna system according to claim 1, wherein the one or more wireless networks comprise a PCS cellular network and a specialized mobile radio network.

7. The distributed antenna system according to claim 1, wherein the backbone comprises a coaxial cable distribution backbone.

8. The distributed antenna system according to claim 1, wherein the plurality of amplifiers comprise bidirectional amplifiers.

9. The distributed antenna system according to claim 1, wherein the facility includes a high-rise building having a plurality of floors, each floor having at least one of the first plurality of antennas, and at least some of the plurality of floors having at least one of the plurality of amplifiers and at least one of the second plurality of antennas.

10. The distributed antenna system according to claim 1, wherein the facility includes a high-rise building having a stairwell and a plurality of floors and the first plurality of antennas is located in the stairwell.

11. The distributed antenna system according to claim 1, wherein the coupler units are low-loss tap coupler units.

12. A distributed antenna system for providing distributed signal coverage within a high-rise, the high-rise having a plurality of floors; the distributed antenna system comprising:
a network backbone running substantially the height of the high-rise;
one or more wireless base stations for receiving wireless signals, each of the wireless base stations coupled to the network backbone;
at least one passive antenna located on each of the plurality of floors, each of the passive antennas connected to the network backbone;
one or more amplifiers located on at least one of the plurality of floors, each amplifier being coupled to the network backbone; and
at least one further antennas, each of the amplifiers being coupled to at least one of the further antennas,
wherein the amplifiers and coupled further antennas distribute the wireless signals during a powered condition and the passive antennas distribute a second set of signals among the floors during a power failure.

13. The distributed antenna system according to claim 12, wherein the second set of signals includes public service wireless signals.

14. The distributed antenna system according to claim 12, further comprising:
an emergency access port coupled to the network backbone,
wherein a command post portable radio coupled to the emergency access port communicates passively with one or more portable radios for use within the high-rise through the passive antennas via the network backbone.

15. The distributed antenna system according to claim 12, further comprising:
a repeater having a normally closed relay coupled to the backbone; and
a directional antenna located exterior to the high-rise and coupled to the repeater for sending and receiving public service signals from a public service base station, the public service signals being:
(a) actively distributed to one or more portable radios over the further antennas during normal powered conditions; and
(b) passively distributed to the one or more portable radios over the passive antennas during a power failure.
